(19) United States
(12) Patent Application Publication
(10) Pub. No.: US 2025/0370321 A1
(43) Pub. Date: Dec. 4, 2025

(54) PROJECTION SYSTEM

(71) Applicant: SEIKO EPSON CORPORATION, Tokyo (JP)

(72) Inventors: Junichi WAKABAYASHI, MATSUMOTO-SHI (JP); Reito SATO, SUWA-SHI (JP)

(21) Appl. No.: 19/220,319

(22) Filed: May 28, 2025

(30) Foreign Application Priority Data
May 31, 2024 (JP) 2024-088753

(51) Int. Cl. G03B 21/20

(52) U.S. Cl. CPC G03B 21/2013; G03B 21/2073

(57) ABSTRACT

A projection system that project an image onto the road surface to paint a road surface marking on the road surface, the projection system, according to present embodiment of the present disclosure, includes a projector that projects the image onto the road surface, a first installation section in which the projector is installed, a base provided with the first installation section, and a movement mechanism that moves the base. Each of red light, green light, and blue light included in the light emitted from the projector and projected onto the road surface is S-polarized light.

The present application is based on, and claims priority from JP Application Serial Number 2024-088753, filed May 31, 2024, the disclosure of which is hereby incorporated by reference herein in its entirety.

### BACKGROUND

### 1. Technical Field

The present disclosure relates to a projection system.

### 2. Related Art

When a road surface marking such as letters or symbols is drawn on a road surface of a road, first, a drawing of the road surface marking is created based on Road Traffic Act. In related art, a survey is performed on the site where the road surface marking is actually to be drawn, and auxiliary lines including outlines of the road surface marking to be drawn are preliminary sketched on the road surface, for example, with a piece of chalk. Paint is then applied by a painting apparatus in accordance with the auxiliary lines preliminary sketched on the road surface. The road surface marking is thus completed.

An on-site survey and preliminary sketching of a road surface marking require efforts, and techniques of a skilled operator are required. Attempts have therefore been made to reduce the efforts of and burdens to the operator. For example, JP-A-2015-086590 discloses a road surface marking painting apparatus configured to be capable of communication with global positioning system (GPS) satellites or quasi-zenith satellites. The road surface marking painting apparatus disclosed in JP-A-2015-086590 displays the shape of a road surface marking to be painted and the position of a painting nozzle on the screen of a display section, such as a liquid crystal display, based on signal radio waves received from various satellites. The road surface marking painting disclosed in JP-A-2015-086590 can perform painting along guidelines on the screen of the display section and readily paint a road surface marking with high accuracy.

In the related art, the techniques of a skilled operator are required to preliminary sketch auxiliary lines, and when the surface on which the auxiliary lines are drawn is a road surface, the traffic in the region where the road surface marking is drawn is restricted or inhibited and the drafting work is performed for a long period in the region, so that a large burden is imposed on the operator. The road surface marking painting apparatus disclosed in JP-A-2015-086590, which requires connection to satellites, is inevitably a large-scale apparatus. Since a satellite communication system can be used under limited environments and used by limited users, it is difficult to easily and quickly use the road surface marking painting apparatus disclosed in JP-A-2015-086590. Therefore, a demand for a system that allows the preliminary sketching work for a road surface marking to be easily and quickly performed and reduction in the burden to a constructor and an operator.

### SUMMARY

A projection system that projects an image onto the road surface to paint a road surface marking on the road surface, the projection system, according to one embodiment of the present disclosure, includes a projector that projects the image onto the road surface, a first installation section in which the projector is installed, a base provided with the first installation section, and a movement mechanism that moves the base. Each of red light, green light, and blue light that is included in the light emitted from the projector and projected onto the road surface is S-polarized light.

### BRIEF DESCRIPTION OF THE DRAWINGS

FIG. 1 is a side view of a projection system according to an embodiment.

FIG. 2 is another side view of the projection system of FIG. 1.

FIG. 3 is a schematic view of the image light forming section of the projection system of FIG. 1.

FIG. 4 is a schematic view of the image light forming section of a modification of the projection system of FIG. 1.

FIG. 5 is a perspective view showing the use of the projection system of FIG. 2 for preliminary sketching of road surface markings.

FIG. 6 is another perspective view showing the use of the projection system of FIG. 2 for preliminary sketching road surface markings.

FIG. 7 is a perspective view showing the use of the projection system of FIG. 1 for preliminary sketching road surface markings.

### DESCRIPTION OF EMBODIMENTS

Hereinafter, embodiments of the present disclosure will be described with reference to the drawings. In the drawings, the scale of dimensions of some components may be changed in order to make the components easy to see.

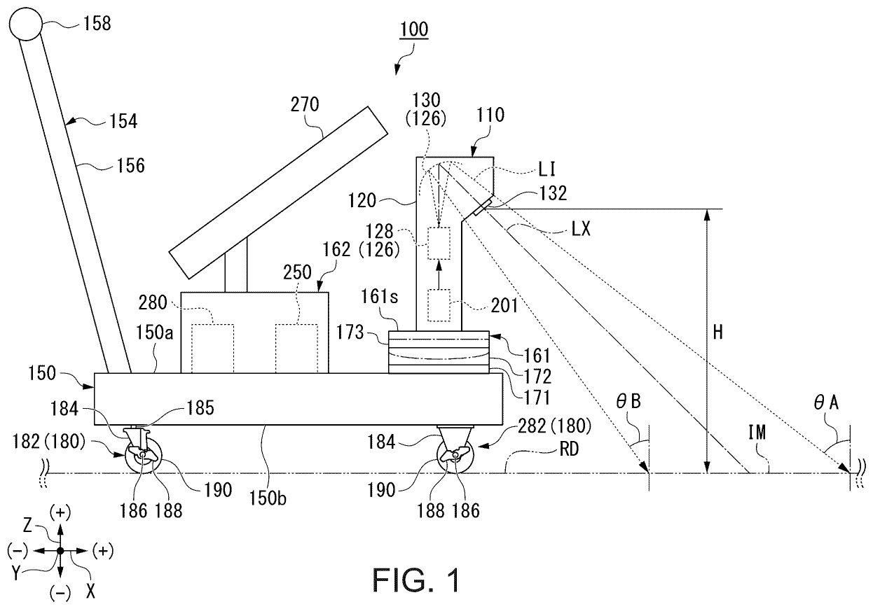

First, an embodiment of the present disclosure will be described with reference to FIGS. 1 to 7. FIG. 1 is a side view showing configuration of a projection system 100 according to the first embodiment of the present disclosure and is a view when viewed along a Y direction described later. The projection system 100 is a system that projects an image onto the road surface RD for painting a marking on the road surface RD. As shown in FIG. 1, the projection system 100 includes a projector 110, a first installation section 161, a base 150, and a movement mechanism 180, and further includes a second installation section 162, a handle section 154, a main body 184 as a movement restriction mechanism, and a stopper 188 as a lock mechanism.

The projector 110 is a projection device that projects an image onto the road surface RD for painting a road surface marking on the road surface RD. The image represents, for example, among road surface markings, simple lines of road markings, symbolic graphics and signs, outlines of letters and numbers, and includes lines and graphics. The format of the road surface marking and the dimensions of the lines and figures contained in the image are defined according to instructions relating to road signs, road marking lines, road markings, and the Road Traffic Act. The image is enlarged when projected onto the road surface RD. Therefore, the original image before projection from the projector 110 is created according to the enlargement ratio and the width or length of the road surface so that the line or figure included in the image when enlarged and projected on the road surface has a dimension based on the above-described instructions.

The road surface RD is an installation surface on which the projection system 100 is installed and a movement surface on which the projection system 100 moves. In the following description, one direction parallel to the road surface RD is referred to as an X direction, one side in the X direction is referred to as a −X side, and the other side in the X direction is referred to as a +X side. A direction parallel to the road surface RD and orthogonal to the X direction is defined as a Y direction, one side in the Y direction is defined as a −Y side, and the other side in the Y direction is defined as a +Y side. A direction orthogonal to the X direction and the Y direction is defined as a Z direction, one side in the Z direction is defined as a −Z side, and the other side in the Z direction is defined as a +Z side. The Z direction is orthogonal to the road surface RD. The −Z side represents a direction relatively approaching the road surface RD and corresponds to the same direction as the vertical direction.

The projector 110 includes an outer housing 120, an image light forming section 201, a projection optical system 126, and a light emitting section 132. The image light forming section 201 and the projection optical system 126 are accommodated in the outer housing 120.

The image light forming section 201 generates image light LI to be projected from the projector 110 onto the road surface RD. The configuration of the image light forming section 201 will be described later.

The projection optical system 126 is provided on an optical path of image light of a predetermined color emitted from the image light forming section 201. At least a part of the projection optical system 126 is arranged on the +Z side with respect to the image light forming section 201.

The projection optical system 126 includes, for example, a lens system 128 and a reflective mirror 130. The lens system 128 is provided on the optical path of the image light LI emitted from the image light forming section 201 and is arranged on the +Z side with respect to the image light forming section 201. The lens system 128 enlarges the image light LI incident from the −Z side at a predetermined magnification set due to the distance from the light emitting section 132 to the road surface RD or the like within a plane orthogonal to the optical axis LX, and appropriately corrects aberrations included in the image light LI. The lens system 128 includes one or more optical lenses. Examples of the optical lens include a plano-convex lens, a plano-concave lens, a biconvex lens, a biconcave lens, a meniscus lens, an aspherical lens, and a free-form surface lens.

The reflective mirror 130 is provided on the optical path of the image light LI emitted from the lens system 128 and is arranged on the +Z side of the lens system 128. The irradiation range on the plane orthogonal to the optical axis LX of the image light LI emitted from the lens system 128 spreads, with the optical axis LX as the center, as the optical path of the image light LI is directed toward the road surface RD and toward the emission side. Specifically, the reflective mirror 130 is provided in a region where the image light LI emitted from the lens system 128 is directly irradiated while spreading as described above. The reflective mirror 130 reflects the image light LI emitted from the lens system 128 to the −Z side and the +X side and emits the image light LI.

The reflection surface of the reflective mirror 130 is provided on the surface on the side on which the image light LI is incident in the reflective mirror 130, moves to the +X side as it goes to the +Z side, and forms a concave curved surface, which is concave when viewed from the incident side of the image light LI. The reflection surface of the reflective mirror 130 regularly reflects the incident image light LI and emits the image light LI to the +X side and the −Z side.

The light emitting section 132 is provided on the optical path of the image light LI emitted from the reflective mirror 130 of the projection optical system 126. Specifically, the light emitting section 132 is provided on an end face that protrudes to the +X side from the portion where the image light forming section 201 and the projection optical system 126 are housed within the outer housing 120. The end face is at a position where it returns to the incident side of the image light LI from the road surface RD according to the irradiation distance as a short-focus type projector on the optical axis LX with respect to the road surface RD, further on the +X side than the distal end of the base 150 where the projector 110 is installed. The end face is inclined with respect to the road surface RD and moves to the +Z side as it moves to the +X side. The light emitting section 132 transmits the image light from the projection optical system 126, which is within the outer housing 120, and directs it to the +X side and the −Z side toward the road surface.

The first installation section 161 is a base portion on which the projector 110 is installed and is provided on the base 150. The base 150 forms the base of the carrying assist mechanism of the projector 110 and is formed plate-shaped with a predetermined thickness and size in the Z direction, for example, and has a plate face 150a facing upwards, that is, to the +Z side, and a plate face 150b facing downwards, that is, to the −Z side. The plate faces 150a and 150b of the base 150 extend substantially parallel to the XY plane including the X direction and the Y direction.

For example, the first installation section 161 is provided on the +X side of the base 150 and is provided on the plate face 150a portion substantially at the center in the Y direction. The first installation section 161 has an installation surface 161s that can be installed from the +Z side of the projector 110. The first installation section 161 is constituted by, for example, a combination of block-shaped stages, and includes rotation stages 171, 172, and 173. The rotation stages 171, 172, and 173 correspond to rotation mechanisms.

The movable section of a rotation stage 171 rotates along the XY plane parallel to the road surface RD about a rotation axis parallel to the Z direction. As the rotation stage 171 rotates, the projector 110 rotates in the XY plane. In FIG. 1, the image light LI from the light emitting section 132 of the projector 110 is emitted toward the +X side and the −Z side with respect to the base 150.

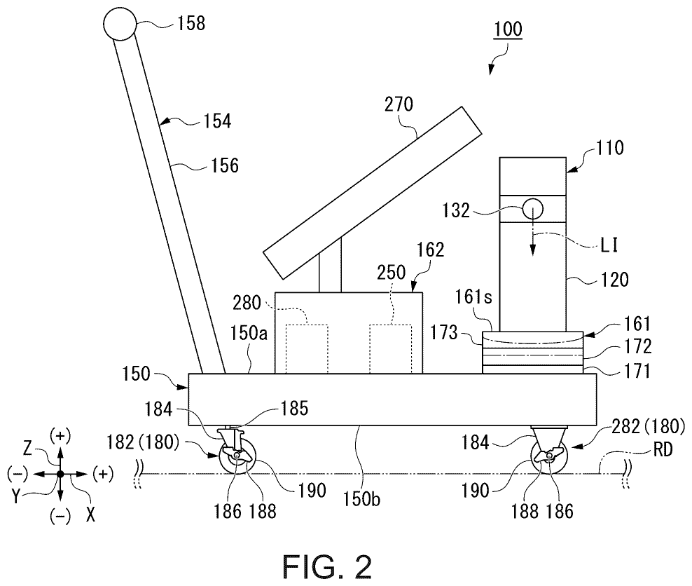

FIG. 2 is a schematic view showing configuration of the projection system 100, viewed along the Y direction, and shows, for example, the state of the rotation stage 171 rotated 90° around the rotation axis from the state shown in FIG. 1. As shown in FIG. 2, for example, the image light LI from the light emitting section 132 of the projector 110 is emitted toward the +Y side or the −Y side and the −Z side with respect to the base 150 by the rotation of the rotation stage 171 of the first installation section 161.

The rotation angle of the rotation stage 171 about the rotation axis is freely adjusted mainly within the range of 180°, that is, within the range of −90° to +90° with reference to the state where the image light LI is emitted along the X direction as shown in FIG. 1.

As shown in FIGS. 1 and 2, the rotation stage 172 is mounted on the +Z side of the rotation stage 171. The movable section of the rotation stage 172 rotates along an XZ plane including the X direction and the Z direction about a rotation axis parallel to the Y direction. When the rotation stage 172 rotates, the projector 110 rotates in the XZ plane, and the direction of the image formed by projecting the image light onto the road surface is finely adjusted.

The rotation stage 173 is mounted on the +Z side of the rotation stage 172. A surface on the +Z side of the rotation stage 173 forms the installation surface 161s. The movable section of the rotation stage 173 rotates along the YZ plane, including the Y direction and the Z direction, about a rotation axis parallel to the X direction. When the rotation stage 173 rotates, the projector 110 rotates in the YZ plane, and the direction of the image formed by projecting the image light LI on the road surface RD is finely adjusted.

The first installation section 161 may include, in addition to the rotation stages 171, 172, and 173, a wall section (not shown) that surrounds the projector 110 from the −Y side, the +Y side, and the +Z side of the projector 110.

The second installation section 162 is a section on which an electronic device 250 that controls the image projected by the projector 110 is installed and is provided on the base 150. The second installation section 162 is provided, for example, on the plate face 150a portion substantially at the center in the X direction and the Y direction of the base 150. The second installation section 162 is, for example, configured in a box shape. The second installation section 162 houses the electronic device 250 and a power supply device 280 for the projector 110 and the electronic device 250.

The electronic device 250 is electrically coupled with the light modulation devices 400B, 400G, and 400R of the projector 110 in a wired or wireless manner (not shown) and transmits information of an original image of a road surface marking to the light modulation devices 400B, 400G, and 400R as image information. The electronic device 250 is, for example, a desktop computer, but may be replaced with a tablet terminal device that can be easily installed in and removed from the second installation section 162.

The electronic device 250 includes a processor that controls an image to be transmitted to the light modulation devices 400B, 400G, and 400R described later. The processor of the electronic device 250 holds information on the original image of the road surface marking. The electronic device 250 controls the image projected on the road surface RD by adjusting the magnitude and the timing of the electric signal related to the image information transmitted to the light modulation devices 400B, 400G, and 400R. The electronic device 250 is also electrically connected to a light source device 122 of the projector 110 in a wired or wireless manner (not shown). The processor of the electronic device 250 adjusts the electric signal for adjusting the light amount of the color light emitted from the light source device 122 with respect to the light source device 122 according to the electric signal related to the image information transmitted to the light modulation devices 400B, 400G, and 400R.

For example, the power supply device 280 is housed inside the box body of the second installation section 162, similarly to the electronic device 250.

A display device 270 is installed in the second installation section 162. The display device 270 is installed on an outer wall surface substantially parallel to the XY plane on the +Z side of the box body of the second installation section 162 via a support section extending along the Z direction.

The display device 270 displays toward the −X side and the +Z side, for example, an image projected by the projector 110, an electric signal transmitted from the electronic device 250 to the light modulation devices 400B, 400G, and 400R, and information regarding the movement of the base 150. The display face of the display device 270 is parallel to the Y direction, is inclined with respect to the X direction and the Z direction when viewed along the Y direction and moves from the −Z side to the +Z side as it moves from the −X side to the +X side. The display device 270 is, for example, a display used for a monitor or the like.

The handle section 154 is a configuration to move the base 150 along the movement surface of the projection system 100 and, for example, is provided on the plate face 150a on the −X side of the base 150, protrudes from the plate face 150a to the +Z side, and moves to the −X side as it moves to the +Z side. The handle section 154 includes two shaft sections 156 and a gripping section 158.

Shaft sections 156 extend to the +Z side from both end sections of the plate face 150a of the base 150 in the Y direction and move to the −X side as they move to the +Z side. The axial center of the shaft sections 156 are inclined with respect to the Z direction when viewed along the Y direction and move from the +X side to the −X side as the axis moves from the −Z side to the +Z side.

The −Z side end of one shaft section 156 of the two shaft sections 156 is connected to the plate face 150a of the end section on the −X side and the −Y side of the base 150. The −Z side end of the other shaft section 156 of the two shaft sections 156 is connected to the plate face 150a of the end section on the −X side and the +Y side of the base 150. The +Z side ends of the shaft section 156 are located on the +Z side with respect to at least the light emitting section 132 of the projector 110, are located further on the +Z side with respect to the end of the display device 270 on the +Z side, and are located further on the −X side with respect to the −X side end of the base 150.

The gripping section 158 is connected to the two shaft sections 156. For example, the gripping section 158 connects the +Z side ends of the two shaft sections 156 along the Y direction and extends along the Y direction. The gripping section 158 is provided so as to be gripped by a user (not shown) of the projection system 100 to move the base 150 along the movement surface of the projection system 100. Therefore, the length of the gripping section 158 in the Y direction is set to, for example, a length having an appropriate margin in the separation distance in the Y direction between both hands of the user when the user of the projection system 100 grips the gripping section 158. The gripping section 158 may be provided with an operation button (not shown) or a display face related to the movement of the base 150 or the like.

The movement mechanism 180 is arranged on the plate face 150b of the base 150 and moves the base 150. The movement mechanism 180 includes, for example, wheels 190 of two casters 282 and wheels 190 of the two casters 182.

The casters 282 are provided on the plate face 150b of each of an end section on the +X side and the −Y side and an end section on the +X side and the +Y side of the base 150. The casters 282 include the main body 184, axles 186, the stopper 188, and the wheels 190. The casters 282 are so-called fixed wheels and are casters without any turning section, in which only the wheels 190 rotate.

In caster 282, the main body 184 is fixed to the plate face 150b and extends from the plate face 150b to the −Z side. The width of main body 184 in the XY plane becomes smaller as it moves toward the −Z side. That is, the main body 184 becomes narrower toward the −Z side. The main body 184 is formed to surround the wheels 190 from both sides in the Y direction. The axles 186 are arranged at a tip end section on the −Z side of the main body 184, extend in parallel to the Y direction, and penetrate a central section of the wheels 190 and an end section on the −Z side of the main body 184 along the Y direction. The wheels 190 rotate in a circumferential direction around the axial center of the axles 186. The −Z side end of wheels 190 is in contact with the road surface RD.

The caster 182 is provided on the plate face 150b of each of an end section on the −X side and the −Y side and an end section on the −X side and the +Y side of the base 150. The caster 182 includes the main body 184, a main shaft 185, the axles 186, the stopper 188, and the wheels 190. The caster 182 is a so-called swivel caster and is a caster in which the main body 184 and the wheels 190 rotate.

The main shaft 185 extends from the plate face 150b of the base 150 along the Z direction. The turning section is connected to the end section of the main shaft on the −Z side and rotates the main body 184 of the caster 182 in the circumferential direction, that is, in the XY plane about the axial center parallel to the Z direction of the main shaft 185. The main body 184 of the caster 182 is connected to the plate face 150b via the main shaft 185 and a turning section (not shown) and extends to the −Z side.

In the caster 182, the axles 186 are arranged at the tip end section on the −Z side of the main body 184, extend in parallel to one direction in the XY plane, and penetrate the central section of the wheels 190 and the tip end section on the −Z side of the main body 184 along the one direction. The main body 184 is formed to surround the wheels 190 from both sides in the direction in which the axles 186 extend.

In the casters 182 and 282, the stopper 188 is provided on the protruding axles 186. The stopper 188 is rotated between a release position and a stop position in a circumferential direction around the axial center of the axles 186 by a foot or the like of a user of the projection system 100. When the stopper 188 is in the release position, the wheels 190 are rotatable in the circumferential direction around the axial center of the axles 186. When the stopper 188 is in the release position, the wheels 190 are rotatable in the circumferential direction around the axial center of the axles 186.

In the casters 182 and 282, the stopper 188 is provided on the outer side of the main body 184 surrounding the wheels 190, that is, on the side opposite to the wheels 190 side of the main body 184 and on the side opposite to the center of the base 150 in the Y direction with respect to the main body 184. The axles 186 penetrate a central section of the stopper 188. The stopper 188 is configured to be rotatable between a release position and a lock position in the circumferential direction around the axial center of the axles 186 by a foot or the like of a user of the projection system 100.

When stopper 188 is in the release position, the wheels 190 are not braked at all, and the movement of the base 150 by the casters 182 and 282 is not restricted. On the other hand, when stopper 188 is in the lock position, the wheels 190 are braked, and the movement of the base 150 by the casters 182 and 282 is restricted. Specifically, the rotation of the wheels 190 is stopped, and the movement of the base 150 by the casters 182 and 282 is stopped. The stoppers 188 of the casters 182 and 282 correspond to a lock mechanism.

As described above, fixed casters 282 are arranged at the +X side end section and both end sections in the Y direction of the base 150, and the swivel casters 182 are arranged at the −X side end section and both end sections in the Y direction of the base 150. Therefore, the traveling direction of the projection system 100 can be freely changed by the rotation of the caster 282 around the axial center of the main shaft 185 in the main body 184. On the other hand, the caster 182 follows the direction in which the projector 110, the display device 270, and the handle section 154 are arranged on the base 150 along the traveling direction of the projection system directed by the caster 282 via the handle section 154.

In the projection system 100, the casters 182 and 282 may be interchangeable in the X direction. That is, the caster 182, which are swivel wheels, may be arranged at the end section on the +X side of the base 150 and at both end sections in the Y direction, and the caster 282, which are fixed wheels, may be arranged at the end section on the −X side of the base 150 and at both end sections in the Y direction.

The base 150, the handle section 154, and the movement mechanism 180 constitute a carrying assist mechanism for mounting the projector 110 in the projection system 100.

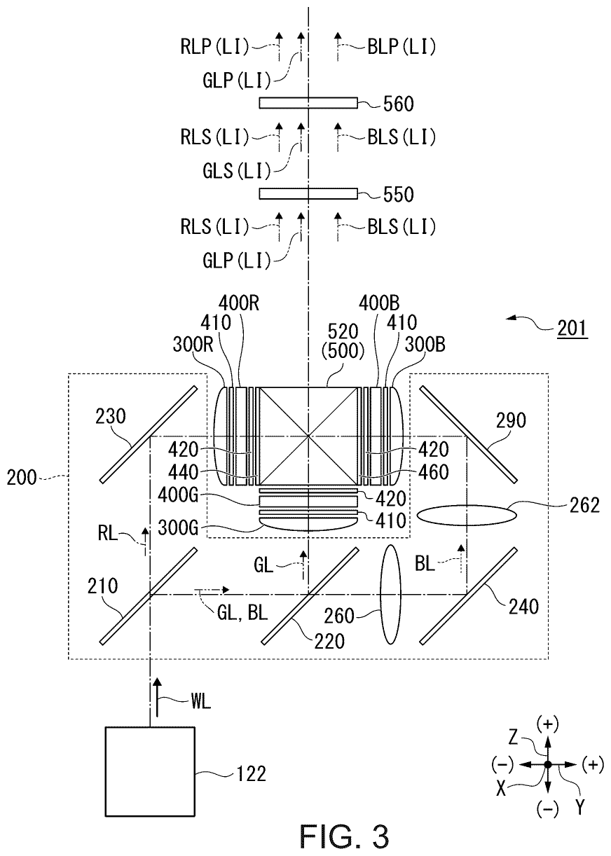

FIG. 3 is a schematic diagram of the image light forming section 201 of the projector 110. As shown in FIG. 3, the image light forming section 201 modulates color light emitted from the light source device 122 to generate image light. The image light forming section 201 includes the light source device 122, a color separation optical system 200, field lenses 300R, 300G, and 300B, light modulation devices 400R, 400G, and 400B, a light-synthesizing element 500, a narrowband phase retardation plate 550, and a passive phase retardation plate 560. The projector 110 including the image light forming section 201 is, for example, a three-plate projector including three light modulation devices.

The light source device 122 emits white light WL including blue light BL, green light GL, and red light RL to generate image light projected from the projector 110 to the +Z side along the Z direction. The white light WL emitted from the light source device 122 is set in accordance with the color of a line or a figure included in an image for painting road surface markings on a road surface and may be replaced with monochromatic light such as green light in some cases. The light source device 122 is, for example, a laser diode (Laser Diode; LD) or a light emitting diode (Light Emitting Diode; LED) that emits predetermined color light.

The color separation optical system 200 separates the incident white light WL into red light RL, green light GL, and blue light BL, and separates each color light onto an individual optical path. The color separation optical system 200 includes, for example, dichroic mirrors 210 and 220, total reflection mirrors 230, 240, and 250, and relay lenses 260 and 262.

A dichroic mirror 210 is arranged on the optical path of the white light WL emitted from the light source device 122. The dichroic mirror 210 transmits the red light RL and reflects the green light GL and the blue light BL. The red light RL, the green light GL, and the blue light BL of the white light WL incident on the dichroic mirror 210 are separated onto different optical paths from each other. The red light RL is transmitted through the dichroic mirror 210 and is emitted toward a total reflection mirror 230. The green light GL and the blue light BL are reflected by the dichroic mirror 210 and are emitted toward the dichroic mirror 220.

The dichroic mirror 220 is arranged on a common optical path of the green light GL and the blue light BL emitted from the dichroic mirror 210. The dichroic mirror 220 transmits the blue light BL and reflects the green light GL. The green light GL and the blue light BL incident on the dichroic mirror 220 are separated onto different optical paths from each other. The green light GL is reflected by the dichroic mirror 220 and is emitted toward the light modulation device 400G. The blue light BL is transmitted through the dichroic mirror 220 and is emitted toward the total reflection mirror 240.

The total reflection mirror 230 is arranged on the optical path of the red color light RL emitted from the dichroic mirror 210 and reflects the incident red color light RL toward the light modulation device 400R. The total reflection mirror 240 is arranged on the optical path of the blue light BL emitted from the dichroic mirror 210 and reflects the incident blue light BL toward a total reflection mirror 290. The total reflection mirror 290 is arranged on the optical path of the blue light BL emitted from the total reflection mirror 240 and reflects the incident blue light BL toward the light modulation device 400B.

A relay lens 260 is arranged on the optical path of the blue light BL between the dichroic mirror 220 and the total reflection mirror 240. A relay lens 262 is arranged on the optical path of the blue light BL between the total reflection mirror 240 and the total reflection mirror 290. The optical path length of the blue light BL from the dichroic mirror 210 to the light modulation device 400B is longer than the optical path length of the red light RL from the dichroic mirror 210 to the light modulation device 400R and the optical path length of the green light GL from the dichroic mirror 210 to the light modulation device 400G. If the relay lens is not arranged on the optical path of the blue light BL, the light loss of the blue light BL is larger than the light loss of the red light RL and the green light GL. Since the relay lens 260 and relay lens 262 are arranged as described above, the light loss of the blue light BL is compensated.

The field lens 300R is arranged on the optical path of the red light RL emitted from the total reflection mirror 230. The field lens 300R aligns the traveling direction of light in a peripheral region of the red light RL having illuminance lower than predetermined illuminance on a plane intersecting the optical axis of the incident red light RL to suppress a reduction in the amount of light in the peripheral region, and emits the red light RL toward the light modulation device 400R.

The field lens 300G is arranged on the optical path of the green light GL emitted from the dichroic mirror 220. The field lens 300G aligns the traveling directions of light in a peripheral region of the green light GL having illuminance lower than predetermined illuminance on a plane intersecting the optical axis of the incident green light GL to suppress a reduction in the amount of light in the peripheral region and emits the green light GL toward the light modulation device 400G.

The field lens 300B is arranged on the optical path of the blue light BL emitted from the total reflection mirror 290. The field lens 300B aligns the traveling direction of light in a peripheral region of the blue light BL having illuminance lower than predetermined illuminance on a plane intersecting the optical axis of the incident blue light BL to suppress a reduction in the amount of light in the peripheral region and emits the blue light BL toward the light modulation device 400B.

The light modulation device 400R is arranged on the optical path of the red color light RL reflected by the total reflection mirror 230 and emitted from the field lens 300R. The light modulation device 400R modulates the incident red light RL in accordance with image information input from the electronic device 250, converts the red light RL into red image light, and emits the red image light toward the light-synthesizing element 500. The image output apparatus is, for example, a personal computer or a portable terminal device.

The light modulation device 400G is arranged on the optical path of the green light GL reflected by the dichroic mirror 220 and emitted from the field lens 300G. The light modulation device 400G modulates the incident green light GL in accordance with image information input from the electronic device 250, converts the green light GL into green image light, and emits the green image light toward the light-synthesizing element 500.

The light modulation device 400B is arranged on the optical path of the blue light BL reflected by the total reflection mirror 290 and emitted from the field lens 300B. The light modulation device 400B modulates the incident blue light BL in accordance with image information input from the electronic device 250, converts the blue light BL into blue image light, and emits the blue image light toward the light-synthesizing element 500.

For example, a transmissive liquid crystal panel is used for each of the light modulation devices 400B, 400G, and 400R. A polarizing plate is arranged in each of an incident-side region and an exit-side region of the liquid crystal panel. That is, each of the light modulation devices 400R, 400G, and 400B includes an incident-side polarizer 410, a liquid crystal panel, and an emission-side polarizer 420, which are sequentially arranged from the incident side to the emission side along the optical path of the incident color light.

The incident-side polarizers 410 are arranged on the optical paths of the red lights RL, the green lights GL, and the blue lights BL emitted from the field lens 300R, 300G, and 300B. The incident-side polarizers 410 emit a predetermined polarization component of the incident color light and block components other than the predetermined polarization component of the color light. The predetermined polarized light is, for example, P-polarized light in which the vibration plane of the color light incident on the incident-side polarizer 410 is parallel to the incident surface of the incident-side polarizer 410. The incident-side polarizers 410 are, for example, absorption type or reflection type polarizing plates having a transmission axis with respect to predetermined polarized light. In order to suppress the return light and the stray lights from the incident-side polarizer 410 to the field lens 300R, 300G, and 300B, the incident-side polarizers 410 are preferably absorption-type polarizing plates.

The liquid crystal panels of the light modulation devices 400B, 400G, and 400R each have a display region and a peripheral region around the display region in a plane intersecting the optical axis of the incident colored light. The display region is provided with a plurality of pixels arranged two dimensionally in a plane intersecting the optical axis of the color light incident on the liquid crystal panel.

The liquid crystal panel of each of the light modulation devices 400B, 400G, and 400R includes a counter substrate, a liquid crystal layer, and an element substrate (none of which are shown), sequentially arranged along the traveling direction of the colored light. In the counter substrate, counter electrodes of a plurality of pixels and various wirings are formed on the plate face facing the liquid crystal layer in the display region. In the element substrate, a plurality of element electrodes corresponding to the plurality of counter electrodes, switching elements, and various wirings are formed on the plate face facing the liquid crystal layer in the display region. The switching element is, for example, a polysilicon thin film transistor (Thin Film Transistor; TFT).

Each pixel of the liquid crystal panels of the light modulation devices 400B, 400G, and 400R modulates the polarization direction of the incident red light RL, green light GL, and blue light BL by the operation of the switching element according to the electric signal corresponding to the image information of the color light mentioned above. The light modulation devices 400R, 400G, and 400B generate red, green, and blue image light, respectively, by the operation of the aforementioned switching elements.

The emission-side polarizers 420 are arranged on the optical paths of the red image light, the green image light, and the blue image light emitted from the liquid crystal panels arranged to correspond to the respective color lights. The emission-side polarizers 420 emit a predetermined polarized component of incident image light and block components other than the predetermined polarized component of the image light. The predetermined polarized light is, for example, P-polarized light in which the vibration plane of the color light incident on the emission-side polarizer 420 is parallel to the incident surface of the emission-side polarizer 420. The emission-side polarizers 420 are, for example, absorptive or reflective polarizing plates having a transmission axis with respect to predetermined polarized light. In order to suppress return light and stray light from the emission-side polarizers 420 to the liquid crystal panel, the emission-side polarizers 420 are preferably absorption-type polarizing plates.

The light-synthesizing element 500 is arranged in a region where the optical path of the red image light emitted from the emission-side polarizer 420 of the light modulation device 400R, the optical path of the green image light emitted from the emission-side polarizer of the light modulation device 400G, and the optical path of the blue image light emitted from the emission-side polarizer of the light modulation device 400B intersect. The light-synthesizing element 500 combines the incident image light of three colors and emits the generated full-color image light toward a projection optical system 600. The light-synthesizing element 500 is formed of, for example, a cross dichroic prism 520.

A half-wave retarder 440, that is, a λ/2 phase plate is arranged on the optical path of the red image light between the emission-side polarizer 420 and the cross dichroic prism 520 of the light modulation device 400R. A half-wave retarder 460, that is, a λ/2 phase plate, is arranged on the optical path of the blue image light between the emission-side polarizer 420 and the cross dichroic prism 520 of the light modulation device 400B.

The cross dichroic prism 520 is composed of four right-angle prisms and two reflecting films (not shown), forming a rectangular parallelepiped. The reflective film is formed of, for example, a dielectric multilayer film. The cross dichroic prism 520 has three incident surfaces on which the three color image light beams are incident, an emission surface from which the full-color image light beam is emitted, a first reflection surface, and a second reflection surface.

Three incident surfaces of the cross dichroic prism 520 constitute three side surfaces of a rectangular parallelepiped and face the emission surfaces of the emission-side polarizers 420 of the light modulation devices 400B, 400G, and 400R. The emission surface of the cross dichroic prism 520 constitutes the remaining one side surface of the rectangular parallelepiped and faces the incident surface of the projection optical system 600. The first reflection surface is arranged on a diagonal line when the rectangular parallelepiped is viewed in a plan view and is arranged so as to form a 45° angle with respect to the incident surface opposed to the emission surface of the emission-side polarizer of the light modulation device 400B in the cross dichroic prism 520 and the emission surface of the cross dichroic prism 520. The first reflection surface transmits the incident red and green image light and reflects the blue image light. The second reflection surface is arranged on the other diagonal line when the rectangular parallelepiped is seen in a plan view and is arranged so as to form a 45° angle with respect to the incident surface opposed to the emission-side polarizer's emission surface of the light modulation device 400R in the cross dichroic prism 520 and the emission surface of the cross dichroic prism 520. The second reflection surface reflects incident red image light and transmits green and blue image light.

The red image light emitted from the emission surface of the emission-side polarizer 420 of the light modulation device 400R passes through the half-wave retarder 440, is converted into S-polarized light, is incident on the cross dichroic prism 520, is transmitted through a part of the first reflection surface, and is reflected toward the emission surface by the second reflection surface. The green image light emitted from the emission surface of the emission-side polarizer 420 of the light modulation device 400G is incident on the cross dichroic prism, is transmitted through the first reflection surface and the second reflection surface, and travels toward the emission surface.

The blue image light emitted from the emission surface of the emission-side polarizer 420 of the light modulation device 400B passes through the half-wave retarder 460, is converted into S-polarized light, is incident on the cross dichroic prism 520, is transmitted through a part of the second reflection surface, and is reflected toward the emission surface by the first reflection surface. The red image light reflected by the second reflection surface, the green image light transmitted through the first reflection surface and the second reflection surface, and the blue image light reflected by the first reflection surface are combined with each other to generate full-color image light.

The narrowband phase retardation plate 550 is arranged on the optical path of the full-color image light emitted from the emission surface of the cross dichroic prism 520, which is the light-synthesizing element 500. The narrowband phase retardation plate 550 imparts no phase difference to the red and blue image light and imparts a phase difference of 180° to the green image light.

The red image light of the image light LI emitted from the emission surface of the cross dichroic prism 520 is the S-polarized image light RLS, passes through the narrowband phase retardation plate 550, and remains unchanged as the S-polarized image light RLS. The green image light of the image light LI emitted from the emission surface of the cross dichroic prism 520 is the P-polarized image light GLP but is incident on the narrowband phase retardation plate 550 to be given a retardation of 180°, and is converted into the S-polarized image light GLS. The blue image light of the image light LI emitted from the emission surface of the cross dichroic prism 520 is the S-polarized image light BLS, passes through the narrowband phase retardation plate 550, and remains unchanged as the S-polarized image light BLS. That is, the image light LI emitted from the narrowband phase retardation plate 550 is the S-polarized image lights RLS, GLS, and BLS in the entire visible wavelength region.

The passive phase retardation plate 560 is arranged on the optical path of the S-polarized image light LI emitted from the narrowband phase retardation plate 550. The passive phase retardation plate 560 may be provided in contact with the emission surface of the narrowband phase retardation plate 550. The passive phase retardation plate 560 imparts a retardation of 180° to the red, green, and blue image light LI included in the image light LI emitted from the narrowband phase retardation plate 550. The passive phase retardation plate 560 is, for example, a passive half-wave retarder, that is, a λ/2 retardation plate. The passive phase retardation plate 560 is composed of, for example, a crystal such as quartz, an oblique vapor deposited structure, or a wire grid structure.

The image lights RLS, GLS, and BLS, which are the S-polarized image light LI emitted from the narrowband phase retardation plate p 550, are incident on the passive phase retardation plate 560, are given a retardation of 180°, and are converted into the red image light RLP, the green image light GLP, and the blue image light BLP, which are the P-polarized image light LI. As shown in FIG. 1, the P-polarized image light LI emitted from the passive phase retardation plate 560 of the image light forming section 201 propagates through the lens system 128 of the projection optical system 126, is reflected by the reflective mirror 130, and is projected toward the road surface RD at a short focal point, thereby becoming S-polarized light when incident on the road surface RD. That is, the image light LI at the time of being incident on the road surface RD after being projected from the projector 110 is S-polarized light.

In the projector 110, the narrowband phase retardation plate 550 and the passive phase retardation plate 560 may be arranged between the lens system 128 or the reflective mirror 130 of the projection optical system 126 of the image light LI and the light emitting section 132.

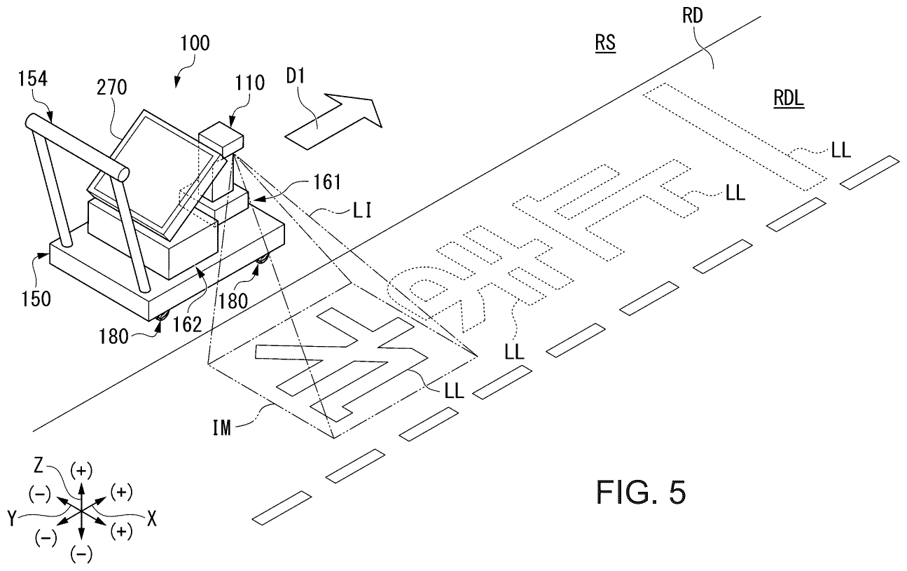

FIGS. 5 to 7 are perspective views illustrating the use of the projection system 100 for preliminary sketching an auxiliary line for a road surface marking to paint the road surface marking. In the present description, as shown in FIG. 5, it is assumed that the road surface RD extends parallel to the XY plane, is long along the x direction, and has a predetermined width based on Road Traffic Act in the y direction. At the center of the road surface RD in the Y direction, a road marking line is drawn along the X direction. When the road surface RD is viewed from the −X side toward the +X side, the road surface RDL on the −Y side with respect to the road marking line is assumed to be a road surface on which the auxiliary line of the road surface marking is preliminary sketched using the projection system 100, and the road surface on which the road surface marking is to be drawn. In the present embodiment, the projection system 100 projects an image IM that is a road surface marking image.

As an example of the aspect of preliminary sketching the auxiliary line of the road surface marking, in the first aspect, as illustrated in FIG. 5, the projector 110 is arranged on the road shoulder surface RS of the road shoulder on the −Y side with respect to the road surface RDL when the road surface RDL is viewed from the −X side toward the +X side. The road shoulder surface RS corresponds to the aforementioned movement surface of the projection system 100, and also corresponds to the road surface RD in FIGS. 1 and 2. In a first aspect, the projection system 100 is in the state illustrated in FIG. 2. That is, the rotation stage 171 of the first installation section 161 is aligned in the circumferential direction so that the image light LI from the projector 110 is emitted toward the +Y side and the −Z side with respect to the base 150.

In the first aspect, the movement direction D1 of the base 150, that is, the projection system 100, is a direction from the −X side toward the +X side along the X direction. FIG. 5 shows by way of example a case where the road surface marking drawn and preliminary sketched on the road surface RDL includes one stop line along the Y direction and the vertically written symbol chain “ [symbol] ” arranged from the +X side to the −X side. In the first aspect, starting from the symbol “ [symbol] ” of the road surface marking, the symbols “ [symbol] ” and “ [symbol] ” and the stop line are sequentially drawn toward the +X side. In the first aspect, the projection direction of the projector 110 is a lateral direction, that is, the +Y side with respect to the movement direction D1 of the base 150. In the first aspect, the orientation of the image IM projected from the projector 110 is from the −X side toward the +X side and is along the movement direction D1 of the base 150.

An operator (not shown) installs the projection system 100 at a position on the road shoulder surface RS in the X direction where a preliminary sketch of the symbol “ [symbol] ” is drafted on the road surface RDL, projects the image light LI onto the road surface RDL from the projector 110, and enlarges and projects an image of the preliminary sketch of the symbol “ [symbol] ”. On the road surface RDL, an outline LL of the symbol “ [symbol] ” having an appropriate dimension according to Road Traffic Act is instantaneously projected. While the outline LL of the symbol “ [symbol] ” is projected on the road surface RDL, an operator (not shown) preliminary sketches an auxiliary line along a part or all of the outline LL of the symbol “ [symbol] ” by using a chalk or the like.

Subsequently, the operator grips the gripping section 158 of the handle section 154, moves the projection system 100 along the movement direction D1, installs the projection system 100 at a position on the road shoulder surface RS where the symbol “ [symbol] ” is to be preliminary sketched on the road surface RDL in the X direction, projects the image light LI onto the road surface RDL from the projector 110, and enlarges and projects the image of the preliminary sketch of the symbol “ [symbol] ”. On the road surface RDL, an outline LL of the symbol “ [symbol] ” having an appropriate dimension according to Road Traffic Act is instantaneously projected. While the visible outline LL of the symbol “ [symbol] ” is projected on the road surface RDL, the operator preliminary sketches an auxiliary line along a part or all of the outline LL of the symbol “ [symbol] ” with a chalk or the like.

The same process, described above, is applied to the road surface marking of the symbol “ [symbol] ”, and the stop line to draw the preliminary sketch of the road surface marking configured with one stop line along the Y direction and the vertically written the symbol chain “ [symbol] ” on the road surface RDL. The operator then applies paint onto the road surface RDL along the preliminary sketch by using a painting apparatus (not shown). The road surface marking of the stop line and the symbol chain “ [symbol] ” is thus completed.

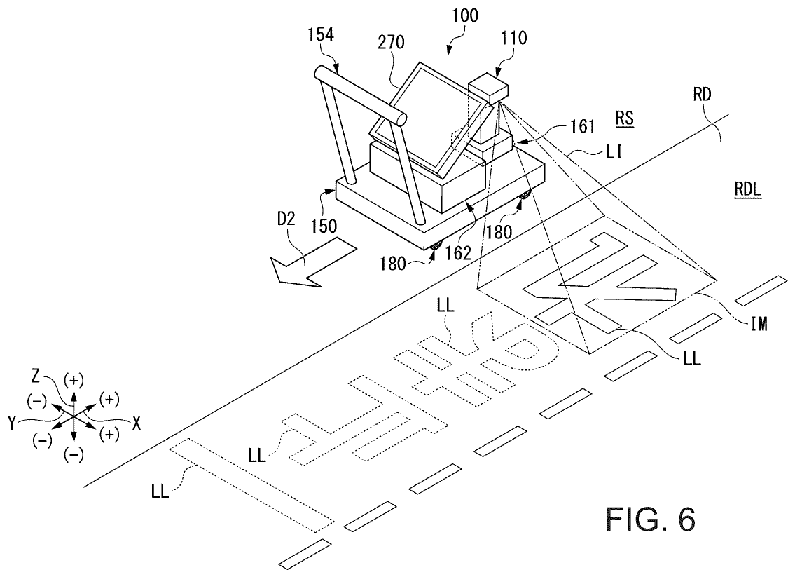

As another example of the aspect of preliminary sketching the auxiliary line of the road surface marking, in a second aspect, as shown in FIG. 6, the projector 110 is arranged on the road shoulder surface RS similarly to the first aspect. In the second aspect as well, the rotation stage 171 of the first installation section 161 is aligned in the circumferential direction so that the image light LI from the projector 110 is emitted toward the +Y side and the −Z side with respect to the base 150.

In the second aspect, the movement direction D2 of the base 150, that is, the projection system 100, is a direction from the +X side toward the −X side along the X direction. FIG. 6 shows by way of example a case where the road surface marking drawn and preliminary sketched on the road surface RDL includes one stop line along the Y direction and vertically written the symbol chain “ [symbol] ” arranged from the −X side to the +X side. In the second aspect, starting from the symbol “ [symbol] ” of the road surface marking, the symbols “ [symbol] ”, “ [symbol] ” and the stop line are sequentially drawn toward the −X side.

In the second aspect, the projection direction of the projector 110 is the lateral direction, that is, the +Y side with respect to the movement direction D2 of the base 150. Also in the second aspect, the orientation of the image IM projected from the projector 110 is the orientation from the −X side toward the +X side and is the orientation along the movement direction D1 of the base 150.

The operator can install the projection system 100 at a position on the road shoulder surface RS where the projection system 100 preliminary sketches the symbol “ [symbol] ” on the road surface RDL in the X direction, and complete the work of preliminary sketching the symbol “ [symbol] ” of the road surface marking on the road surface RDL by carrying out the same process as in the first aspect.

Subsequently, the operator (not shown) grips the gripping section 158 of the handle section 154, moves the projection system 100 along the movement direction D2, and positions it at a location where the symbol “ [symbol] ” is to be preliminary sketched on the road surface RDL in the X direction on the road shoulder surface RS. Then, the projector 110 projects the image light LI onto the road surface RDL, enlarging the preliminary sketch image of the symbol “ [symbol] ”. On the road surface RDL, an outline LL of the symbol “ [symbol] ” having an appropriate dimension according to Road Traffic Act is instantaneously projected. While the outline LL of the symbol “ [symbol] ” is projected on the road surface RDL, the worker preliminary sketches an auxiliary line along a part or all of the outline LL of the symbol “ [symbol] ” with a chalk or the like.

The same process, described above, is applied to the road surface marking of the symbol “ [symbol] ”, and the stop line to draw the preliminary sketch of the road surface marking configured with one stop line along the Y direction and the vertically written the symbol chain “ [symbol] ” on the road surface RDL. The operator then applies paint onto the road surface RDL along the preliminary sketch by using a painting apparatus (not shown). The road surface marking of the stop line and the symbol chain “ [symbol] ” is thus completed.

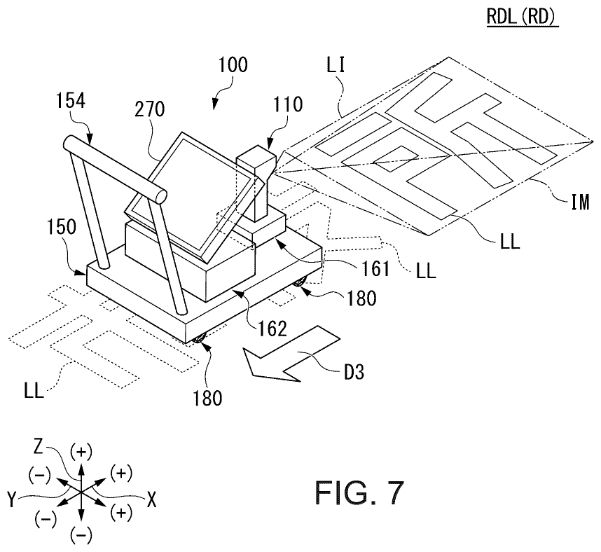

As another example of the aspect t of preliminary sketching the auxiliary line of the road surface marking, in a third aspect, as shown in FIG. 7, the projector 110 is arranged on the road surface RDL. In a third aspect, the projection system 100 is in the state illustrated in FIG. 1. That is, the rotation stage 171 of the first installation section 161 is aligned in the circumferential direction so that the image light LI from the projector 110 is emitted toward the +X side and the −Z side with respect to the base 150.

In the third aspect, the movement direction D3 of the base 150, that is, the projection system 100, is a direction from the +X side toward the −X side along the X direction. FIG. 7 shows by way of example a case where the road surface marking to be drawn and preliminary sketched on the road surface RDL is the horizontally written symbol chain “ [symbol] ” arranged from the −X side to the +X side. In the third aspect, starting from the symbol “ [symbol] ” of the road surface marking, the symbols “ [symbol] ” and “ [symbol] ” are sequentially drawn toward the −X side. In the third aspect, the projection direction of the projector 110 is opposite to the movement direction D3 of the base 150 in the X direction, that is, a direction from the −X side toward the +X side. In the third aspect, the orientation of the image IM projected from the projector 110 is from the +Y side toward the −Y side and intersects the movement direction D3 of the base 150.

The operator can install the projection system 100 at a position where the symbol “ [symbol] ” is to be preliminary sketched on the road surface RDL in the X direction, and complete the work of preliminary sketching the symbol “ [symbol] ” of the road surface marking on the road surface RDL by carrying out the same process as in the first aspect.

Subsequently, the operator (not shown) grips the gripping section 158 of the handle section 154, moves the projection system 100 along the movement direction D3, installs the projection system 100 at a position where the symbol “ [symbol] ” is to be preliminary sketched on the road surface RDL in the X direction, projects the image light LI on the road surface RDL from the projector 110, and enlarges and projects the image of the preliminary sketch of the symbol “ [symbol] ”. On the road surface RDL, the outline LL of the symbol “ [symbol] ” having an appropriate dimension according to Road Traffic Act is instantaneously projected. While the outline LL of the symbol “ [symbol] ” is projected on the road surface RDL, the worker preliminary sketches an auxiliary line along a part or all of the outline LL of the symbol “ [symbol] ” with a chalk or the like.

The same process is applied to “ [symbol] ” of the road surface marking to draw the preliminary sketch of the road surface marking configured with the horizontally written “ [symbol] ” along the Y direction on the road surface RDL. The operator then applies paint to the road surface RDL along the preliminary sketch by using the painting apparatus (not shown). The road surface marking “ [symbol] ” is thus completed.

Next, in the present embodiment, an aspect in which the operator can suitably preliminary sketch the road surface marking by the road surface marking image, which is the image IM projected onto the road surface RD by the projection system 100, will be described.

Table 1 shows an example of the relationship between the size of the image IM when the aspect ratio of the image IM projected on the road surface RD is changed, the height H of the light emitting section 132 of the projector 110 from the road surface RD, and the throw ratio of the projection system 100. The unit of the size of the image IM is inches, and the unit of the height H of the light emitting section 132 from the road surface RD is millimeters.

TABLE 1

| | | HEIGHT H [mm] OF | |
|---|---|---|---|
| | | LIGHT EMITTING | |
| ASPECT RATIO | SIZE [in] OF | SECTION FROM | THROW |
| OF IMAGE IM | IMAGE IM | ROAD SURFACE | RATIO |
| 16:10 | 80 | 100 | 0.058 |
| | | 300 | 0174 |
| | | 500 | 0.290 |
| | | 800 | 0.464 |
| | | 1000 | 0.580 |
| 16:9 | 80 | 100 | 0.056 |
| | | 300 | 0.169 |
| | | 500 | 0.282 |
| | | 800 | 0.452 |
| | | 1000 | 0.565 |
| 4:3 | 80 | 100 | 0.062 |
| | | 300 | 0.185 |
| | | 500 | 0.308 |
| | | 800 | 0.492 |
| | | 1000 | 0.615 |
| 16:10 | 200 | 100 | 0.023 |
| | | 300 | 0.070 |
| | | 500 | 0.116 |
| | | 800 | 0.186 |
| | | 1000 | 0.232 |
| 16:9 | 200 | 100 | 0.023 |
| | | 300 | 0.068 |
| | | 500 | 0.113 |
| | | 800 | 0.181 |
| | | 1000 | 0.226 |
| 4:3 | 200 | 100 | 0.025 |
| | | 300 | 0.074 |
| | | 500 | 0.123 |
| | | 800 | 0.197 |
| | | 1000 | 0.246 |

The size of the image IM is the size of the image IM projected on the road surface RD and is, for example, 80 inches or more and 200 inches or less. Thus, it is possible to suitably project the road surface marking image of the actual size to be preliminary sketched on the road surface RD. The aspect ratio of the image IM is a ratio between the length of the image IM along the horizontal direction and the length of the image IM along the vertical direction.

The height H of the light emitting section 132 from the road surface RD is the length from the center of the light emitting section 132 to the road surface RD on which the image IM is projected, in other words, is a projection distance. Here, the height H of the light emitting section 132 from the road surface RD is, for example, 100 mm or more and 1,000 mm or less. As described above, the height H of the light emitting section 132 from the road surface RD is set to, for example, 1,000 mm or less so as not to exceed the height of the gripping section 158 from the movement surface, and is further set to 100 mm or more so as to form a large road surface marking image of 80 inches or more and 200 inches or less.

The throw ratio of the projection system 100 is a value obtained by dividing the projection distance, that is, the height H, by the length of the image IM along the horizontal direction. The throw ratio of the projection system 100 is, for example, 0.023 or more and 0.615 or less. Therefore, the road surface marking image can be projected on the road surface RD by the ultra-short focus projection using the short-focus type projector 110. In addition, it is possible to suppress that an object that blocks the image will be arranged or enter between the light emitting section 132 of the projector 110 and the road surface RD on which the image IM is projected. Further, there is no loss in the road surface marking image, and the state of the road surface marking image projected on the road surface RD can be more suitably maintained.

The projection system 100 of the present embodiment described above is a projection system that projects an image for painting a road surface marking on the road surface RD onto the road surface RD, and includes the projector 110, the first installation section 161, the base 150, and the movement mechanism 180. The projector 110 projects the image IM onto the road surface RD. The projector 110 is installed in the first installation section 161. The base 150 is provided with the first installation section 161. The movement mechanism 180 moves the base 150. In the projection system 100 according to the present embodiment, each of the red light, the green light, and the blue light included in the image light (light) LI projected onto the road surface RD from the projector 110 and displayed on the road surface RD is S-polarized light.

In order to simplify the process of preliminary sketching the marking before painting by the operator in the construction of painting the road surface marking, in the projection system 100 of the present embodiment, the image light LI, which is the projection image projected from the projector 110, is P-polarized light and is S-polarized light with reference to the road surface RD. The projection target of the projection system 100 is not a white screen or a white wall as for a normal projector, but a road surface RD, that is, for example, asphalt that is gray or black. By using the projection system 100 of the present embodiment, the image light LI of the marking image for the preliminary sketch that the projection system projects onto the primarily gray asphalt road surface RD can enhance the visibility of the image selected by the operator, compared to if the image light LI were P-polarized with reference to the road surface RD.

In the related art, surveying on the road surface RD is performed before the preliminary sketching working work of the road surface marking. However, in the projection system 100 of the present embodiment, for example, since data relating to the road surface RD can be acquired in advance at the stage of creating the original image and can be reflected in the original image, it is not necessary to perform a survey on the road surface RD again immediately before the preliminary sketching work. For this reason, it is possible to reduce the burden on the builder or the operator by using the projection system 100.

In the related art, when there is a large amount of traffic in the daytime on the road surface RD on which the road surface marking is to be drawn, the preliminary sketching work of the road surface marking is performed under a situation where the road is closed at night. In this case, for example, the operator performs the preliminary sketching work in a state where night illumination is mounted on his head or the like. However, in the projection system 100 according to the present embodiment, the image light LI projected from the projector 110 onto the road surface RD also serves as the illumination during the preliminary sketching work, and the visibility of the image IM of the road surface RD is improved. Therefore, the operator does not have to wear an illumination device, and there is no need to separately install strong illumination.

By using the projection system 100 in the present embodiment, it is possible to reduce the road surface marking work time, including the preliminary sketching work, and to shorten the duration of measures such as road closures. Further, even in a case where the projection system 100 of the present embodiment is used in the daytime, the visible outline LL of the image IM projected on the road surface RD is easily visually checked as the light emitting section. For these reasons, it is possible to reduce the burden on the builder or the operator by using the projection system 100.

In the projection system 100 according to the present embodiment, the projector 110 includes light modulation devices 400R, 400G, and 400B that modulate color light (light) emitted from the light source device 122, and the projection optical system 126 that projects image light (light) LI emitted from the light modulation devices 400R, 400G, and 400B as an image IM. The projection optical system 126 includes the reflective mirror 130 that refracts the optical path of the image light LI incident from the light modulation devices 400R, 400G, and 400B.

According to the projection system 100 of the present embodiment, since the projection optical system 126 includes the reflective mirror 130, it is possible to position the projector 110 close to the road surface RD in the Z direction, that is, on the −Z side in a region on the +Z side with respect to the base 150, and to bring the light emitting section 132 of the projector 110 close to the road surface RD. Therefore, it is possible to reduce the possibility of an object that blocks the image light LI and the image IM being arranged or entering between the projector 110 and the road surface RD, and it is possible to suitably maintain a state in which the image IM is projected onto the road surface RD by the projector.

The projector 110 is a short-focus type projector. In the X direction, the difference between the incident angle θB of the image light LI on the road surface RD on the −X side close to the projector 110 and the incident angle θA of the image light LI on the road surface RD on the +X side far from the projector 110 is large, for example, 45° or more. When the difference between the incident angle θA and the incident angle θB is large, the difference between the reflectance from the road surface RD of the image light LI close to the projector 110 and the reflectance from the road surface RD of the image light LI far from the projector 110 is large, and there is a possibility that the visibility of the image IM is lowered. Since the projection system 100 according to the present embodiment includes the short-focus type projector 110 as described above, it is required to suppress a decrease in the visibility of the image IM and improve the visibility of the image IM. In the projection system 100 of the present embodiment, since the image light LI is S-polarized with reference to the road surface RD, the visibility of the image IM is improved.

In the projection system 100 according to the present embodiment, the projector 110 includes the light emitting section 132 from which image light (light as an image) LI is emitted from the outer housing 120 of the projector. The size of the image IM on the road surface is 80 inches or more and 200 inches or less. The height H of the light emitting section 132 from the road surface RD is 100 mm or more and 1,000 mm or less. The throw ratio of the projection system 100 in the present embodiment is 0.023 or more and 0.615 or less.

In the projection system 100 according to the present embodiment, the projector 110 is arranged at a position close to the road surface RD, and the image IM is projected in a large image size. According to the projection system 100 of the present embodiment, it is possible to project an image IM of a size sufficient to project the actual size road surface marking for the preliminary sketch on the road surface RD, and it is possible to reduce the occurrence of objects that block the image light LI and the image IM being placed or entering between the projector 110 and the road surface RD, and it is possible to suitably maintain the state in which the image IM is projected on the road surface RD.

In the projection system 100 of the present embodiment, the projector 110 further includes the light-synthesizing element 500, a passive phase retardation plate (phase retardation element) 560, and the projection optical system 126. The light-synthesizing element 500 combines the red light RL, the green light GL, and the blue light BL of the white light emitted from the light source device 122. The passive phase retardation plate 560 is arranged on the light emission side of the light-synthesizing element 500, and aligns the polarization of the red light RL, the green light GL, and the blue light BL with each other. The projection optical system 126 projects the image light (light) LI emitted from the passive phase retardation plate 560.

By using the projection system 100 in the present embodiment, the image light LI that the projection system projects onto the primarily gray asphalt road surface RD of the marking image for the preliminary sketch can enhance the visibility of the image selected by the operator, compared to when the image light LI is P-polarized with reference to the road surface RD.

In the projection system 100 according to the present embodiment, the base 150 includes the second installation section 162 on which the electronic device 250 that controls the image IM projected by the projector 110 is installed.

According to the projection system 100 in the present embodiment, it is possible to easily adjust the image IM suitable for preliminary sketching the road surface marking by the electronic device 250, and to mount the electronic device 250 on the second installation section 162 and stabilize the electronic device 250 with respect to the base 150.

The projection system 100 according to the present embodiment further includes the handle section 154 having the gripping section 158 to be gripped by a user to move the base 150. In the projection system 100 according to the present embodiment, the projector 110 has the light emitting section 132 from which image light (light) LI as an image is emitted from the outer housing 120. The height of the light emitting section 132 from the road surface RD is lower than the height of the gripping section 158 from the road surface RD.

According to the projection system 100 of the present embodiment, the light emitting section 132 of the projector 110 can be brought closer to the road surface RD than the position at which the user grips the gripping section 158.

In the projection system 100 according to the present embodiment, for example, the projection direction of the projector 110 may be a lateral direction with respect to the movement directions D1 and D2 of the base 150. In this case, the direction of the image IM projected from the projector 110 is a direction along the movement directions D1 and D2 of the base 150.

The projection system 100 in the present embodiment, for example, can project the image IM onto the road surface RD from the road shoulder surface RS on the lateral of the road surface RD where the preliminary sketch of the road surface marking is to be performed, and instantaneously create the preliminary sketch of the road surface marking in the direction along the extension direction of the road surface RD.

In the projection system 100 according to the present embodiment, for example, the projection direction of the projector 110 may be a direction opposite to the movement direction D3 of the base 150. In this case, the direction of the image IM projected from the projector 110 is a direction intersecting the movement direction D3 of the base 150.

According to the projection system 100 of the present embodiment, it is possible to project the image IM onto the road surface RD where the preliminary sketch of the road surface marking is to be made, and to instantly create a preliminary sketch of the road surface marking in a direction that intersects with the extension direction of the road surface RD.

The projection system 100 of the present embodiment further includes, for example, a main body (movement restriction mechanism) 184 that restricts the movement directions D1, D2, and D3 of the base 150 moved by the casters 282 as the movement mechanism 180 to predetermined directions.

According to the projection system 100 of the present embodiment, since the movement direction of the wheels 190 and the base 150 is determined in a predetermined direction by the main body 184, which does not rotate with respect to the movement surface and the road surface RD in the caster 282, it is possible to accurately move the base 150 and to stabilize the base 150.

The projection system 100 according to the present embodiment further includes a stopper (lock mechanism) 188 that restricts the movement of the base 150 by the movement mechanism 180.

According to the projection system 100 of the present embodiment, in the casters 182 and 282 as the movement mechanism 180, when the stopper 188 is switched to the lock position, the rotation of the wheels 190 can be easily stopped and the unexpected movement of the base 150 can be prevented. For example, when the road surface RD is inclined with respect to the horizontal plane, the projection system 100 can be stabilized on the movement surface and the road shoulder surface RS by switching the stopper 188 from the release position to the lock position while the image IM for preliminary sketching the road surface marking is projected from the projection system 100 onto the road surface RD. As a result, it is possible to reduce the burden on the builder and the operator.

The projection system 100 according to the present embodiment further includes rotation stages (rotation mechanisms) 171, 172, and 173. The rotation stage 171 is provided in the first installation section 161 and changes the projection direction of the projector 110 with respect to the movement directions D1, D2, and D3 of the base 150 by rotating the projector 110.

According to the projection system 100 of the present embodiment, it is possible to freely and easily adjust the emission direction of the image light LI from the projector 110 and the orientation of the image IM according to the relative position between the installation surface of the projection system 100, that is, the movement surface, and the road surface RD, or the relative relationship between the installation position of the projection system 100 and the position where the image IM is to be projected on the road surface RD. This increases the range of use of projection system 100.

In the projection system 100 according to the present embodiment, the rotation stage (rotation mechanism) 171 rotates the projector 110 in a direction along the road surface RD.

According to the projection system 100 of the present embodiment, it is possible to freely and easily adjust the emission direction of the image light LI from the projector 110 in the XY plane parallel to the road surface RD using the rotation stage 171.

In the projection system 100 according to the present embodiment, the rotation stages (rotation mechanism) 172 and 173 rotate the projector 110 in the Z direction intersecting the direction along the road surface RD.

According to the projection system 100 of the present embodiment, it is possible to freely and easily adjust the orientation of the image IM projected from the projector 110 onto the road surface RD by adjusting the posture of the projector 110 in the plane including the Z direction orthogonal to the road surface RD using the rotation stages 172 and 173.

### Other Embodiments

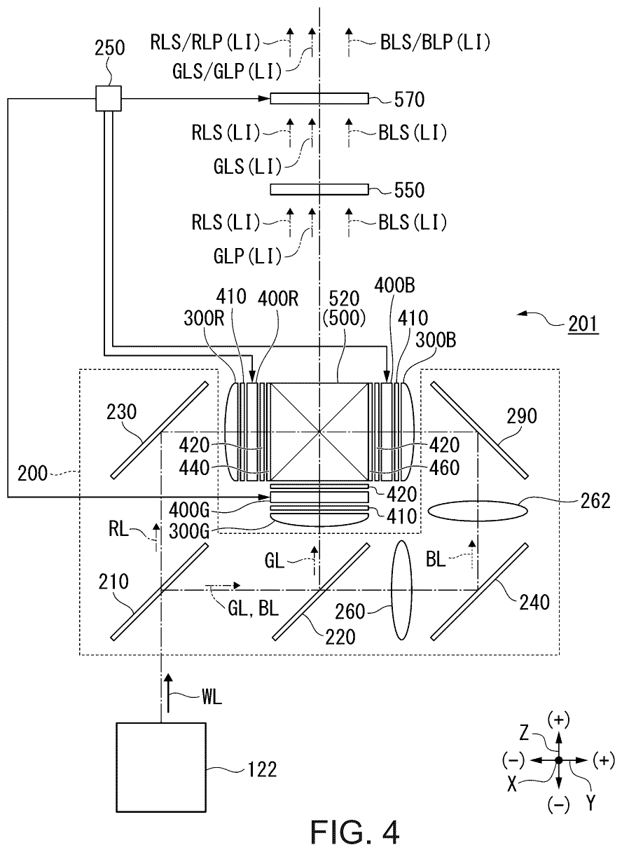

Next, a modification of the projection system 100 according to the present embodiment will be described. FIG. 4 is a schematic diagram of the image light forming section 201 of a modification of the projector 110. As shown in FIG. 4, in the modification of the projection system 100 of the present embodiment, an active phase retardation element 570 is provided instead of the passive phase retardation plate 560 of the projector 110. The active phase retardation element 570 is electrically coupled with the electronic device 250 in a wired or wireless manner.

The active phase retardation element 570 is formed of, for example, a VA-mode liquid crystal cell, and is AC-driven by the electronic device 250. In such a configuration, when the voltage between the pixel electrodes is 0 [V], the liquid crystal molecules of the active phase retardation element 570 periodically stand with respect to the optical path, and the phase of the image light LI passing through the active phase retardation element 570 changes. When the voltage between the pixel electrodes is 5 [V], which is larger than 0 [V], the liquid crystal molecules of the active phase retardation element 570 fall with respect to the optical path, and the phase of the image light LI passing through the active phase retardation element 570 does not change. By the above-described operation and switching, when the voltage between the pixel electrodes is 0 [V], the image light LI passing through the active phase retardation element 570 can be P-polarized light, and when the voltage between the pixel electrodes is 5 [V], a retardation of Δ/2=180° can be imparted to the image light LI passing through the active phase retardation element 570, and the image light LI can be S-polarized light.

The image light LI emitted from the active phase retardation element 570 is periodically switched between the P-polarized image lights RLP, GLP, and BLP and the S-polarized image light RLS, GLS, and BLS, and thus a repelling effect is exhibited against insects, which cause discomfort to a operator in outdoor work on the road surface RD at night. The cycle at which the image light LI is switched between the P-polarized light and the S-polarized light is appropriately set so that the operator does not feel discomfort due to the above-described insects, and is, for example, 1 to 20 [Hz].

Since the reflectance on the road surface RD is different between the S-polarized light and the P-polarized light of the image light LI, switching between the S-polarized light and the P-polarized light may cause flickering for the operator. In this case, the flickering is reduced by synchronizing the drive of the active phase retardation element 570 and the drive of the light modulation devices 400R, 400G, and 400B, and performing projection while switching the gradation-transmittance characteristics of the liquid crystal panels of the light modulation devices 400R, 400G, and 400B between those for S-polarized light and those for P-polarized light. Basically, in the gradation-transmittance characteristics of the liquid crystal panel, the phase modulation amount for P-polarized light and the brightness of the image light LI are larger than the phase modulation amount for S-polarized light and the brightness of the image light LI.

For example, in consideration of human visibility, γ=2.2 is set. The set value of the brightness of the S-polarized light having relatively high reflection on the road surface RD is set to be reduced by 30% with respect to the set value of the brightness of the P-polarized light having poor reflection on the road surface RD. Voltages to be applied to the liquid crystal panels are set on the basis of the each set values and the V-T characteristics of the liquid crystal panels. Accordingly, gradation data for both P-polarization and S-polarization are set. The set value of the brightness of the S-polarized light is, for example, reduced by 30% with respect to the set value of the brightness of the P-polarized light, but is appropriately set in consideration of the main standing position of the operator, the emission position of the image light LI from the projector, the diffusion characteristics of the road surface RD, and the like.

In the modification of the projection system 100 according to the present embodiment, the projector 110 further includes the active phase retardation element (polarization switching element) 570 and the electronic device (first control device) 250. The active phase retardation element 570 is arranged on the light emission side of the narrowband phase retardation plate (phase retardation element) 550 and switches the polarization state of the image light (light) LI exiting from the narrowband phase retardation plate 550 between P-polarization and S-polarization. The electronic device 250 controls the active phase retardation element 570. Specifically, the electronic device 250 switches between a first polarization state in which S-polarized red image light (red light), green image light (green light), and blue image light (blue light) are projected as the image light LI on the road surface RD and a second polarization state in which P-polarized red image light (red light), green image light (green light), and blue image light (blue light) are projected as the image light LI on the road surface RD.

According to the modification of the projection system 100 of the present embodiment, the image light LI on the road surface RD is switched between the S-polarized light and the P-polarized light and exhibits a repelling effect on insects. Therefore, it is possible to prevent a decrease in work efficiency due to insects approaching the image light LI, and to reduce the discomfort of the operator.

In the modification of the projection system 100 according to the present embodiment, the projector 110 includes the light modulation device (first light modulation device) 400R, the light modulation device (second light modulation device) 400G, the light modulation device (third light modulation device) 400B, and the electronic device (second control device) 250. The light modulation device 400R modulates the red color light RL included in the image light LI emitted from the light source device 122. The light modulation device 400G modulates the green light GL included in the image light LI. The light modulation device 400B modulates the blue light BL included in the image light LI.

The electronic device 250 controls each of the light modulation devices 400R, 400G, and 400B. To be specific, the electronic device 250 reduces the light amount (first light amount) of at least one color light of the color lights emitted from the light modulation devices 400R, 400G, and 400B in the P-polarized light (first polarized state), that is, the light amount (first light amount) of the P-polarized image light LI of at least one color of red, green, and blue to be lower than the light amount (second light amount) of at least one color light in the S-polarized light (second polarized state).

According to the modification of the projection system 100 of the present embodiment, by switching the image light LI on the road surface RD between S-polarized light and P-polarized light as described above, a decrease in work efficiency due to insects approaching the image light LI is prevented, and the discomfort of the operator is reduced, and the light quantity of the S-polarized image light LI and the P-polarized image light LI on the road surface RD, as well as the difference in light quantity between the S-polarized light and P-polarized light of the image light LI, can be appropriately set to reduce flickering of the image light LI on the road surface RD.

Although the preferred embodiments of the present disclosure have been described in detail above, the present disclosure is not limited to the specific embodiments, and various modifications and changes can be made within the scope of the gist of the present disclosure described in the claims.

### Summary of Present Disclosure

Hereinafter, a summary of the present disclosure is appended.

### Appendix 1

A projection system that projects an image onto a road surface to paint a road surface marking on the road surface, the projection system includes a projector that projects the image onto the road surface; a first installation section on which the projector is installed; a base provided d with the first installation section; and a movement mechanism that moves the base, wherein each of red light, green light, and blue light that is included in light emitted from the projector and that is projected onto the road surface is S-polarized light.

According to the configuration of Appendix 1, since the image of the preliminary sketch such as the outline of the road surface marking is instantaneously projected from the projector onto the road surface, the time required for the preliminary sketching work of the road surface marking performed in the related art is reduced. According to the configuration of Appendix 1, the preliminary sketching work of the road surface marking can be simply and easily performed, and the burden on the builder and the operator can be reduced. With the configuration of Appendix 1, it is possible to increase the visibility of the image selected by the builder or the like compared to a case where the light is P-polarized light on the basis of the road surface with respect to mainly gray asphalt.

### Appendix 2

In the projection system according to Appendix 1, wherein the projector has a light modulation device configured to modulate light emitted from a light source device and a projection optical system that projects the light emitted from the light modulation device as the image and the projection optical system includes a reflective mirror that refracts the optical path of the light incident from the light modulation device.

According to the configuration of Appendix 2, the projector can be arranged at a position close to the road surface.

### Appendix 3

In the projection system according to Appendices 1 or 2, the projector includes a light emitting section from which light as the image is emitted from the outer housing of the projector, wherein a size of the image on the road surface is 80 inches or more and 200 inches or less, a height of the light emitting section from the road surface is 100 mm or more and 1,000 mm or less, and a throw ratio is 0.023 or more and 0.615 or less.

According to the configuration of Appendix 3, the projector can be brightly positioned close to the road surface.

### Appendix 4

In the projection system according to Appendix 2, the projector further includes a light-synthesizing element that combines red light, green light, and blue light of the light emitted from the light source device, a phase retardation element that is arranged on a light emission side of the light-synthesizing element and that aligns polarization of the red light, the green light, and the blue light, and the projection optical system that projects the light emitted from the phase retardation element.

With the configuration of Appendix 4, it is possible to efficiently align the polarized light of the color light incident on the light modulation device to the S-polarized light, and to enhance the visibility of the image on the road surface.

### Appendix 5

In the projection system according to Appendix 4 wherein the projector further has a polarization switching element that is arranged on the light emission side of the phase retardation element and that switches a polarization state of light emitted from the phase retardation element and a first control device configured to control the polarization switching element, wherein the first control device switches between a first polarization state in which the red light, the green light, and the blue light of S-polarized light are projected onto the road surface and a second polarization state in which the red light, the green light, and the blue light of P-polarized light are projected onto the road surface.

With the configuration of Appendix 5, it is possible to switch the light emitted from the projector between the first polarization state and the second polarization state to prevent insects from approaching the light, thereby reducing discomfort caused by insects moving to the image projected on the road surface.

### Appendix 6

In the projection system according to Appendix 5 wherein the projector further includes a first light modulation device that modulates the red light included in the light emitted from the light source device, a second light modulation device that modulates the green light included in the light emitted from the light source device, a third light modulation device that modulates the blue light included in the light emitted from the light source device, and a second control device configured to control the first light modulation device, the second light modulation device, and the third light modulation device and the second control device controls the first light modulation device, the second light modulation device, and the third light modulation device such that a first light amount in the first polarization state of at least one color light of the color lights emitted from the first light modulation device, the second light modulation device, and the third light modulation device is lower than a second light amount in the second polarization state.

With the configuration of Appendix 6, it is possible to increase the amount of light in the second polarization state, that is, the P-polarized light emitted from the projector, and to enhance the visibility of the image on the road surface.

### Appendix 7

In the projection system according to any one of Appendices 1 to 6, the base includes a second installation section in which an electronic device that controls the image projected by the projector is installed.

With the configuration of Appendix 7, it is possible to easily adjust the image suitable for preliminary sketching the road surface marking by the electronic device, and to mount the electronic device on the second installation section and stabilize the electronic device with respect to the base.

### Appendix 8

The projection system according to any one of Appendices 1 to 7, further including a handle section has a gripping section to be gripped by a user to move the base, wherein the projector includes a light emitting section from which light forming the image is emitted from the outer housing of the projector, a height of the light emitting section from the road surface is lower than the height of the gripping section from the road surface.

With the configuration of Appendix 8, it is possible to bring the light emitting section of the projector closer to the road surface than the position at which the user grips the gripping section.

### Appendix 9

The projection system according to any one of Appendices 1 to 8, wherein a projection direction of the projector is lateral to a movement direction of the base and an orientation of the image projected from the projector is along the movement direction of the base.

With the configuration of Appendix 9, it is possible to project an image onto the road surface from the road shoulder surface on the lateral of the road surface on which the road surface marking is to be preliminary sketched, and preliminary sketches the road surface marking in a direction along the extension direction of the road surface.

### Appendix 10

The projection system according to any one of Appendices 1 to 8, wherein a projection direction of the projector is opposite to a movement direction of the base and the orientation of the image projected from the projector intersects the movement direction of the base.

With the configuration of Appendix 10, it is possible to project the image onto the road surface on which the road surface marking is to be preliminary sketched, and preliminary sketches the road surface marking in the direction intersecting the extension direction of the road surface.

### Appendix 11

The projection system according to any one of Appendices 1 to 10, further including a rotation mechanism that is provided in the first installation section and changes a projection direction of the projector with respect to a movement direction of the base by rotating the projector.

With the configuration of Appendix 11, it is possible to freely and easily adjust the emission direction of the light from the projector and the orientation of the image, and to widen the range of use of the projection system.

What is claimed is:

1. A projection system that projects an image onto a road surface to paint a road surface marking on the road surface, the projection system comprising:
a projector that projects the image onto the road surface;
a first installation section on which the projector is installed;
a base provided with the first installation section; and
a movement mechanism that moves the base, wherein
each of red light, green light, and blue light that is included in light emitted from the projector and that is projected onto the road surface is S-polarized light.

2. The projection system according to claim 1, wherein
the projector includes
a light modulation device configured to modulate light emitted from a light source device and
a projection optical system that projects the light emitted from the light modulation device as the image and
the projection optical system includes a reflective mirror that refracts the optical path of the light incident from the light modulation device.

3. The projection system according to claim 1, wherein
the projector includes a light emitting section from which light forming the image is emitted from the outer housing of the projector,
a size of the image on the road surface is 80 inches or more and 200 inches or less,
a height of the light emitting section from the road surface is 100 mm or more and 1, 000 mm or less, and
a throw ratio is 0.023 or more and 0.615 or less.

4. The projection system according to claim 2, wherein
the projector further includes
a light-synthesizing element that combines red light, green light, and blue light of the light emitted from the light source device,
a phase retardation element that is arranged on a light emission side of the light-synthesizing element and that aligns polarization of the red light, the green light, and the blue light, and
the projection optical system that projects the light emitted from the phase retardation element.

5. The projection system according to claim 4, wherein
the projector further includes
a polarization switching element that is arranged on the light emission side of the phase retardation element and that switches a polarization state of light emitted from the phase retardation element and
a first control device that is configured to control the polarization switching element and
the first control device switches between a first polarization state in which the red light, the green light, and the blue light of S-polarized light are projected onto the road surface and a second polarization state in which the red light, the green light, and the blue light of P-polarized light are projected onto the road surface.

6. The projection system according to claim 5, wherein
the projector further includes
a first light modulation device that modulates the red light included in the light emitted from the light source device,
a second light modulation device that modulates the green light included in the light emitted from the light source device,
a third light modulation device that modulates the blue light included in the light emitted from the light source device, and
a second control device configured to control the first light modulation device, the second light modulation device, and the third light modulation device and
the second control device controls the first light modulation device, the second light modulation device, and the third light modulation device such that a first light amount in the first polarization state of at least one color light of the color lights emitted from the first light modulation device, the second light modulation device, and the third light modulation device is lower than a second light amount in the second polarization state.

7. The projection system according to claim 1, wherein
the base includes a second installation section where an electronic device that controls the image projected by the projector is installed.

8. The projection system according to claim 1, further comprising:
a handle section that includes a gripping section to be gripped by a user to move the base, wherein
the projector includes
a light emitting section from which light forming the image is emitted from an outer housing of the projector and
a height of the light emitting section from the road surface is lower than the height of the gripping section from the road surface.

9. The projection system according to claim 1, wherein
a projection direction of the projector is lateral to a movement direction of the base and
an orientation of the image projected from the projector is along the movement direction of the base.

10. The projection system according to claim 1, wherein
a projection direction of the projector is opposite to a movement direction of the base and
an orientation of the image projected from the projector intersects the movement direction of the base.

11. The projection system according to claim 1, further comprising:
a rotation mechanism that is provided in the first installation section and that, by rotating the projector, changes a projection direction of the projector with respect to a movement direction of the base.
